(19) United States
(12) Patent Application Publication
(10) Pub. No.: US 2011/0102299 A1
(43) Pub. Date: May 5, 2011

(54) Display Configuration Method for a Remote Visualization System

(75) Inventors: Roland M. Hochmuth, Fort Collins, CO (US); Byron A. Alcorn, Fort Collins, CO (US)

(73) Assignee: HEWLETT-PACKARD DEVELOPMENT COMPANY, L. P., Houston, TX (US)

(21) Appl. No.: 13/000,625

(22) PCT Filed: Jul. 1, 2008
(86) PCT No.: PCT/US2008/068914

§ 371 Date: Dec. 21, 2010

(51) Int. Cl. G09G 5/00

(52) U.S. Cl. 345/1.2

(57) ABSTRACT

A display method is provided for a remote visualization system (100) including a remote computer (120) and a local computer (140). The method includes the steps of: detecting a quantity of physical displays (160) connected with the local computer (140); specifying a physical display of the physical displays (160) for displaying a visualization window that is operable for accessing resources of the remote computer; according to the specifying step, communicating to the remote computer (120) attributes which define the specified physical display; according to the communicating step, generating a virtual display at the remote computer (120), the virtual display matching the communicated attributes; substantially simultaneously with the generating step, displaying a visualization window on the specified physical display; and mapping the virtual display to the visualization window.

### BACKGROUND OF THE INVENTION

Today's designers and engineers are working with increasingly large data sets and complex models and simulations. Whether it is increased reality of an animated movie or an in-depth simulation of a prototype device, the need for higher performance computing, more data and increased realism is the order of the day. Remote visualization or graphics (referred to collectively herein as “remote visualization”) systems are used by designers and engineers to view data from afar and collaborate via remote visualization sessions. As known in the art, a remote visualization system provides a “just like local” experience by allowing a user of a local computer to access and use computing resources (e.g., share the desktop) of a remote computer e.g. a supercomputer).

Since the work done by today's designers and engineers is very detailed and complex, the engineers and designers utilizing a remote visualization system often employ multiple (e.g., two or more) physical display devices or monitors (hereinafter referred to as local displays or physical displays) at the local computer because the visualizations are too detailed or too large to fully render on a single display at a desired resolution. Additionally, designers and engineers often multi-task by displaying and using various local applications (i.e., applications residing and/or executing on the local computer) in various application windows on the multiple displays. Each application window may be contained within one local display or, alternatively, may span across two or more local displays.

When rendering pixel information on the local displays relative to locally-executing applications (i.e., non remote-executing applications such as the operating system desktop, etc), various display-configuring applications (e.g., DualView mode of the Microsoft Windows XP operating system, nView from NVIDIA, and the like known in the art) may be employed by a user to configure the local displays so that different locally-executing applications are associated with one or more of the local displays. As known in the art, such display-configuring applications manage the local displays by subdividing an aggregate display size or resolution into multiple logical displays, each of which is then associated with a different local display. For example, if two displays are configured side by side (for example, as shown in FIG. 2) with each display having a pixel dimension (also referred to hereinafter as “resolution” or “display resolution”) of 1280×1024, the operating system of the local computer would determine an aggregate display size of 2560×1024 which the display-configuring application then subdivides (e.g., using heuristics) into two logical displays.

Although conventional display-configuring applications are useful for managing the local displays relative to locally-executing applications, such conventional display-configuring applications do not cooperate with remote visualization systems. Moreover, such conventional display-configuring applications often complicate the configuration of local displays for remote visualization. Accordingly, a new display method for a remote visualization system would be an important improvement in the art.

### BRIEF DESCRIPTION OF THE DRAWINGS

FIG. 1 illustrates a block diagram of an embodiment of a remote visualization system; and

FIGS. 2-4 diagrammatically illustrate various example embodiments of a local display apparatus for the system of FIG. 1.

### DETAILED DESCRIPTION

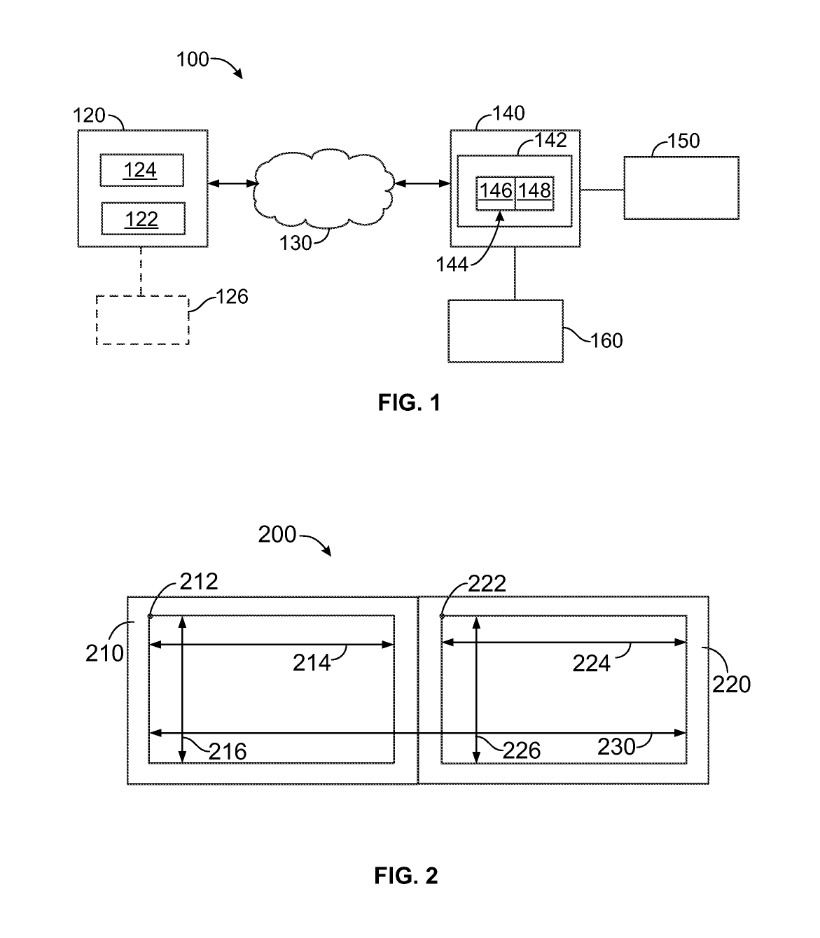

Turning now to the Figures a display method for a remote visualization system is provided. As shown in FIG. 1. an example embodiment of the remote visualization system is designated as 100. The remote visualization system 100 includes a remote computer 120 and a local computer 140 which communicate with each other via a network 130. The remote computer 120 may be any computing device known in the art, for example a personal computer such as a desktop or laptop, a blade workstation, a supercomputer, etc. Similarly, the local computer 140 may be any computing device known in the art, for example a personal computer such as a desktop or laptop, a thin client with an embedded operating system, a FDA, etc. The local computer 140 may be employed, by a user for accessing and utilizing resources of the remote computer 120. Herein, the local computer 140 is described in the context of being employed by a user for accessing and utilizing visualization or graphics resources of the remote computer 120, however, the local computer 140 may be employed for other purposes as well. In some instances the remote computer 120 may have resources (e.g., computational power, specialized applications, etc.) that are substantially different or that exceed the resources of the local computer 140. However, in other instances the remote computer 120 may have substantially similar resources as the local computer 140. As shown, the local computer 140 communicates with the remote computer 120 (and vice versa) via a network 130 (e.g., a LAN or WAN, the Internet, a virtual private network (VPN), etc.). However, the remote and local computers 120, 140 may communicate with each other directly, for example over a wired or wireless point-to-point connection. Alternatively, the remote and local computers 120, 140 may communicate with each other directly or indirectly via an ad hoc peer-to-peer connection.

As shown, the remote computer 120 includes a visualization application 122 and a graphics server application 124. The visualization application 122 resides and/or executes on the remote computer 140 for processing data and remotely rendering images relative to the processed data. A remote display 126, which is optionally included or omitted relative to the configuration of the remote computer 120 as indicated by depiction of the remote display 126 in broken lines, is connected with the remote computer 120 for displaying images rendered by the visualization application 122. In embodiments of the system 100 wherein the remote computer 120 is a blade workstation or server blade, the remote display 126 is omitted because a frame buffer or graphics card of the blade workstation or server blade is not accessible via a connector. The graphics server application 124 is in communication with the visualization application 122 (as well as other applications available on the remote computer 120) for receiving pixel information generated by the visualization application 122 (and which could be remotely rendered on the remote display 126 if present). The graphics server application 124 receives the pixel information, processes the pixel information (e.g., using compression and/or encryption techniques), and transmits the processed pixel information to the local computer 140, particularly a graphics client application 142 executing on the local computer 140.

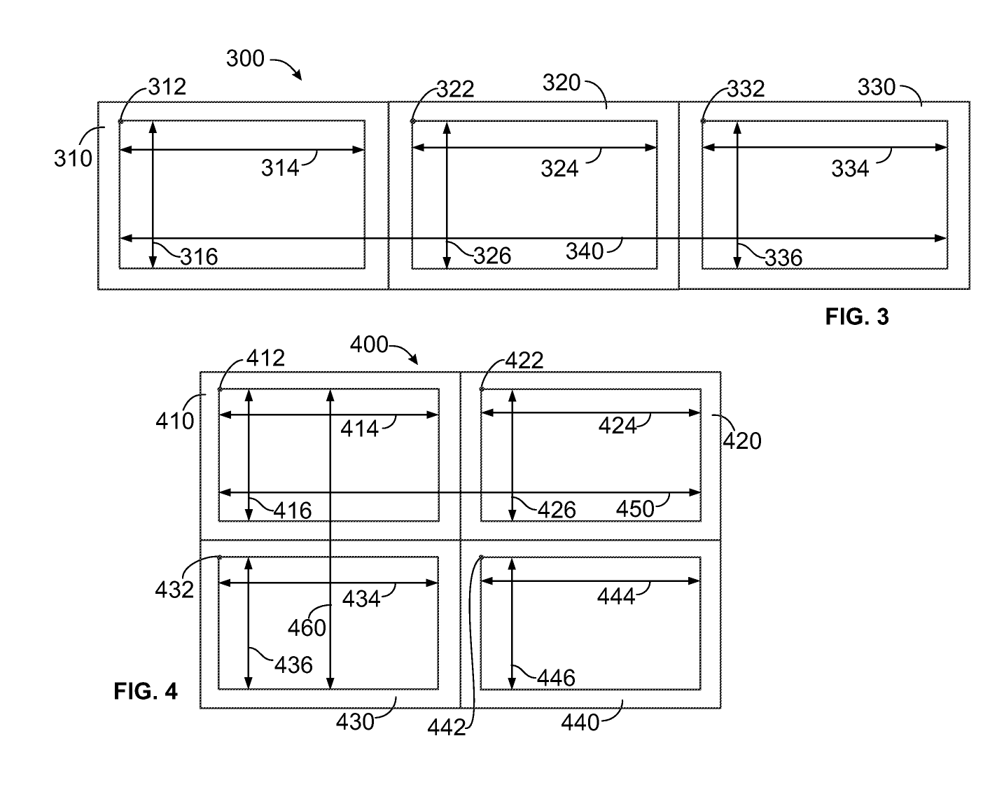

The local computer 140 is configured at a second location, which may be remote from or proximate to (e.g., in the same room or building) the remote computer 120. Connected with the local computer 140 are a user input 150 (e.g., a keyboard, mouse, etc.) and a display apparatus 160. The display apparatus 160 comprises two or more local, physical display devices (e.g., CRT monitors or displays, LCD monitors or displays, etc.). Although the two or more local, physical display devices may be the same type and have similar sizes or resolutions, indeed the two or more physical display devices may be different types (e.g., one CRT and one LCD) and/or have different sizes and/or resolutions. As can be appreciated, the two or more local, physical display devices constituting display apparatus 160 may be physically oriented, arranged or otherwise configured in various ways as shown for example in FIGS. 2-4 which illustrate various embodiments of display apparatus 160.

As shown, the local computer 140 includes a graphics client application 142 which is a local client application counterpart to the graphics server application 124 of the remote computer 120. That is, the graphics client application 142 communicates with the graphics server application 124 (and vice versa) for initiating/establishing and maintaining a remote visualization session between the local computer 140 and the remote computer 120 via the network 130. As will be explained hereafter, the graphics client application 142 and the graphics server application 124 cooperate to provide application transparency—allowing a user of the local computer 140 to access and use remote applications on the remote computer 120 as if the remote applications were residing and/or executing on the local computer 140.

More particularly, the graphics client application 142 is operable to generate one or more visualization windows that “cover” one or more physical display devices of the display apparatus 160 connected with the local computer. Although the graphics client application 142 may generate more than one visualization window, for convenience of explanation hereinafter the graphics client application 142 is described as generating one visualization window per visualization session. If additional visualization windows are desired, the user of the local computer 140 may initiate other visualization sessions by executing the graphics client application 142 multiple times, for example, with respect to various remote computers that may be the same as or different than remote computer 120. The visualization window generated by the graphics client application 142 may be similar in appearance and/or operation/functionality to “task windows” that may be generated by the operating system of the local computer 140. As known in the art, task windows are used for concurrent, segregated display of different locally-originating data (e.g., different applications being executed on the local computer 140, etc.) on the same display device. However, in contrast to task windows, the visualization window is used for displaying data, graphics or visualizations that originate from the remote computer 120, particularly the visualization application 122 in cooperation with the graphics server application 124.

The graphics client application 142 receives user input signals regarding the remote visualization session (e.g., visualization commands) from the user input 150 and, relative to the user input signals, transmits the user input signals to the graphics server application 124 so that a user of the local computer 120 can interact with the visualization application 122 via the visualization window being displayed on a local display device (of apparatus 160) just as if the user were physically interacting with the remote computer 120. In response to the user input signal at the local computer 140, the graphics server application 124 communicates with the visualization application 122 which performs a corresponding visualization operation (e.g., resize, move or otherwise change an object being rendered/visualized). Relative to the visualization operation, the visualization application 122 outputs pixel information which is received by the graphics server application 124. The graphics server application 124 communicates the pixel information to the graphics client application 142 which renders the pixel information in the visualization window being displayed on the display device of display apparatus 160. Since the foregoing-described operations are performed quickly and with low latency, the system 100 provides a user of the local computer 140 with the “just like local” feel of working solely with locally-executing applications.

To configure the visualization window for covering one or more desired local display devices of the display apparatus 160, the graphics client application 142 includes a display layout module 144. The display layout module 144 determines a physical layout of one or more local display devices that constitute the display apparatus 160 by communicating with the local computer 140. As shown, the display layout module 144 includes a display quantity module 146 and a display arrangement module 148. The display quantity module 146 communicates with the local computer 140 (for example, by interfacing with the operating system and/or BIOS of the local computer 140) to detect how many local display devices constitute the display apparatus 160. For example, as shown in FIG. 2, the display quantity module 146 would detect that embodiment 200 of display apparatus 160 includes two display devices 210 and 220. The display quantity module 146 communicates the detected quantity to the graphics client application 142 which in turn communicates a first quantity to the remote computer 120, particularly the graphics server application 124. Hereinafter, the first quantity defines the number of local display devices “covered” by the visualization window generated by the graphics client application 142 in cooperation with the graphics server application 124. That is, the first quantity relates to the number of local display devices that are specified for participation in a remote visualization session between the graphics server application 124 and the graphics client application 142. As can be appreciated, the first quantity may be one so that a single display device is covered by the single visualization window (i.e., the visualization window occupies substantially all or at least a portion of the display area of the display device). However, the first quantity may be greater than one so that any number of display devices may be used for remote visualization.

In response to receiving the first quantity and information regarding the display device which is to display the visualization window the graphics server application 124 communicates with the graphics client application 142 for initiating, creating or otherwise generating the visualization window that will cover the first quantity of local physical display devices. Furthermore, in response to receiving the first quantity the graphics server application 124 generates a virtual display at the remote computer 120. The graphics server application 124 and the graphics client application 142 communicate with each other for associating or mapping the virtual display with the visualization window. The virtual display and the visualization window may be generated substantially simultaneously or sequentially. By employing the visualization window the user of the local computer 140 may initiate and operate the visualization application 122 relative to the virtual display so that pixel information generated by the application 122 (and “displayed” on the virtual display) is received by the graphics server application 124 and sent to the graphics client application 142 for rendering the pixel information and displaying a visualization or graphics in the visualization window which is being displayed on the first quantity of local physical display devices. As such, it can be appreciated that data being displayed on the visualization window is substantially similar to data being “displayed” on the virtual display.

As previously mentioned, the first quantity may be equal to the detected quantity of display devices so that all detected local display devices are used in the remote visualization session. However, the first quantity may be less than the detected quantity if the user of the local computer desires to selectively employ one or more of the local physical displays thr the remote visualization session. In some instances, the user may specify a subset of local display devices that the user wishes to cover with the visualization window. In this way other display devices not in the subset may be used for displaying “local” information (i.e., information generated by an application being executed by the local computer 140). However, in other instances the covering of one or more display devices with the visualization window may be accomplished based on a default setting or a user's predetermined preference that is defined by a user profile. One example default setting for the visualization window may be to cover the leftmost display device (e.g., display 210 shown in FIG. 2).

The display arrangement module 148 cooperates with the display quantity module 146 for configuring the visualization window according to the physical attributes of the local display device or devices which are to be covered by the visualization window. Also, in instances when more than one visualization windows are used relative to more than one local display devices, the display arrangement module 148 cooperates with the display quantity module 146 for configuring the visualization windows according to the physical layout/configuration of the display devices. The display arrangement module 148 may communicate with the local computer 140 for determining attributes of the devices of the display apparatus 160. Attributes may include but are not limited to a resolution expressed/defined as either a total number of pixels or a pixel dimension (e.g., a number of horizontal and vertical pixels such as 1280×1024 meaning 1280 horizontal pixels by 1024 vertical pixels), a coordinate relative to a predetermined reference point such as a (0,0) horizontal-vertical (i.e., x-y) pixel origin of a default or selected local display), and an orientation (e.g., landscape or portrait) of each local display device of the display apparatus 160. As can be appreciated, if resolution is expressed or defined as a pixel dimension, the orientation may be inherently defined by the resolution/pixel dimension. By communicating the quantity, resolution, coordinate and orientation information to the graphics server application 124, the system 100 is operable to automatically match the visualization window to a desired or specified display device. Alternatively, a user may communicate with the display arrangement module 148 (e.g., using the user input 150) for specifying or otherwise customizing of the configuration of virtual displays and corresponding visualization windows.

Referring now to FIG. 2, an example of a display method is provided according to a first embodiment 200 of the display apparatus 160 (FIG. 1). As shown in FIG. 2, the first embodiment 200 of display apparatus 160 includes two local displays 210, 220 in a side-by-side horizontal arrangement. The first local display 210 is configured to the left of and adjacent to the second local display 220. The first local display 210 includes a coordinate 212 and a resolution/orientation defined by the horizontal pixel dimension 214 and the vertical pixel dimension 216. Similarly, the second local display 220 includes a coordinate 222 and a resolution/orientation defined by the horizontal pixel dimension 224 and the vertical pixel dimension 226. For convenience of description hereinafter, vertical pixel dimensions 216, 226 are substantially similar and coordinate 212 is to be defined as the predetermined reference point or (0,0) pixel origin. However, vertical pixel dimensions 216, 226 being substantially similar should not be taken as limiting the present system and method. Furthermore, coordinate 212 being defined as the predetermined reference point or (0,0) pixel origin should not be taken as limiting the present system and method. Indeed, coordinate 222 or other point on one of the first and second local displays 210, 220 may be used as the predetermined reference point as well. The overall or aggregate resolution of the display apparatus 200 is defined by the overall horizontal pixel dimension 230 and the vertical pixel dimension 216 or 226.

Now, during the initiation of the remote visualization session, for example, the display quantity module 146 detects a quantity of two local displays 210, 220 and the display arrangement module 148 determines that the first local display 210 has attributes defined by: 1) its coordinate 212 relative to a reference point; and 2) its resolution/orientation—the first local display 210 being expressed as (X₁, Y₁, W₁, H₁), wherein X₁=0, Y₁=0, W₁=the horizontal pixel dimension 214 (e.g., 1280 pixels, and H₁=the vertical pixel dimension 216 (e.g., 1024 pixels). Similarly, the display arrangement module 148 determines that the second local display 220 has attributes expressed as (X₂, Y₂, W₂, H₂), wherein X₂=an offset equal to the horizontal pixel dimension 214 (e.g., 1280 pixels), Y₂=0, W₂=the horizontal pixel dimension 224 (e.g., 1280 pixels), and H₂=the vertical pixel dimension 226 (e.g., 1024 pixels). That is, the second local display 220 is offset in the positive direction (i.e., to the right) by the horizontal pixel dimension 214 of the first local display 210.

If the single visualization window is to cover display 210, the graphics client application 142 communicates the quantity (i.e., 1) and an attribute of the display 210 (i.e., (X₁, Y₁, W₁, H₁)) to the graphics server application 124 so that the graphics server application 124 generates a single virtual display and the corresponding visualization window in a one-to-one correspondence with the local display 210. Similarly, if the single visualization window is to cover display 220, the graphics client application 142 communicates the quantity (i.e., 1) and an attribute of the display 220 (i.e., (X₂, Y₂, W₂, H₂)) to the graphics server application 124 so that the graphics server application 124 generates a single virtual display and the visualization window in a one-to-one correspondence with the local display 220. In both of the foregoing examples relating to the covering of only one display (i.e., display 210 or 220) of a multi-display arrangement, it should be understood that the coordinates (X₁, Y₁) and (X₂, Y₂) are both defined to be (0,0) regardless of the predetermined reference point because the single remote display that is generated need not be translated or offset. For example, even when the reference point is set as point 212 and the visualization window is to cover only the right display device 220, the graphics server application 124 generates the remote display at (0,0) (i.e., of a remote desktop of the remote computer 120) not at (X₂, Y₂) since there is only one remote display corresponding to the visualization window covering the desired display device. That is, while the visualization window is to be offset on the client desktop to (X₂, Y₂), that doesn't mean there is an offset of the remote display on the remote desktop. In another instance where the graphics client application 142 is used to generate two visualization windows—one visualization window covering each display 210, 220, the graphics client application 142 communicates the quantity (i.e., 2) and attributes of the displays 210, 220 (i.e., (X₁, Y₁, W₁, H₁) and (X₂, Y₂, W₂, H₂)) to the graphics server application 124 so that the graphics server application 124 generates first and second virtual displays and first and second visualization windows in a one-to-one correspondence with the local displays 210, 220 respectively. In this case, at least one of the coordinates (X₁, Y₁) and (X₂, Y₂) is defined to not be (0,0).

In some instances the user may wish to specify or designate how many visualization windows are generated, or otherwise specify how visualization windows are to be associated or mapped with one or more of the physical local display devices for customizing the covering of display devices with visualization windows (e.g., adjusting the virtual display offset or virtual display resolution). As mentioned previously, the covering of one or more display devices with visualization windows may be based on a default setting such as, for example causing the visualization window to cover the display that a user employs for initiating the graphics client application 142. Alternatively, the covering of one or more display devices with visualization windows may be based on a user's predetermined preference that is defined by a user profile. However, in some other instances the user may interface with the graphics client application 142 (e.g., using the user input 150) to adjust or customize the attributes/configuration of the virtual displays and visualization windows. For example, the user may execute or launch the graphics client application 112 multiple times for generating multiple visualization windows. In this example, the user may specify how each visualization window covers one or more of the display devices (e.g., referring to FIG. 2, a first visualization window generated by a first executed client application may cover display 210 whereas a second visualization window generated by a subsequently executed client application may cover display 220 or vice versa). Indeed, the user may specify or customize the configuration of the visualization windows and virtual displays relative to the local displays in numerous ways.

Referring now to FIG. 3, a second embodiment 300 of the display apparatus 160 (FIG. 1) is described. As shown in FIG. 3, the second embodiment 300 of display apparatus 160 includes three local displays 310, 320, 330 in a side-by-side horizontal arrangement. The first local display 310 is configured to the left of and adjacent to the left side of second local display 320, and the third local display 330 is configured to the right of and adjacent to the right side of second local display 320 such that second local display 320 is a central local display of the apparatus 300. The first local display 310 includes a coordinate 312 and a resolution defined by the horizontal pixel dimension 314 and the vertical pixel dimension 316. Similarly, the second local display 320 includes a coordinate 322 and a resolution defined by the horizontal pixel dimension 324 and the vertical pixel dimension 326. Finally, the third local display 330 includes a coordinate 332 and a resolution defined by the horizontal pixel dimension 334 and the vertical pixel dimension 336. For convenience of description hereinafter, vertical pixel dimensions 316, 326, 336 are substantially similar and coordinate 312 is to be defined as the predetermined reference point or (0,0) pixel origin. However, vertical pixel dimensions 316, 326, 336 being substantially similar should not be taken as limiting the present system and method. Furthermore, coordinate 312 being defined as the predetermined reference point or (0,0) pixel origin should not be taken as limiting the present system and method. Indeed, coordinates 322, 332 or other point on one of the local displays 310, 320, 330 may be used as the predetermined reference point as well. The overall or aggregate resolution of the display apparatus 300 is defined by the overall horizontal pixel dimension 340 and the vertical pixel dimension 316, 326 or 336.

Since various examples of covering displays of a display apparatus 160 constituting two-display devices 210, 220 have been discussed previously with respect to FIG. 2, the covering of displays 310, 320, 330 of a three-display device 300 shown in FIG. 3 will not be repeated for brevity. However, it can be appreciated that the user may wish to cover one or more of the displays 310, 320, 330 in various ways (e.g., with one or more visualization windows relative to one or more virtual displays). For example, the user may execute or launch the graphics client application 142 up to three times for generating three different and distinct visualization windows. In this example, the user may specify how each of the three visualization windows covers one or more of the display devices 310, 320, 330. Referring to FIG. 3, a first visualization window generated by a first executed client application may cover display 310 whereas second and third visualization windows generated by subsequently-executed client applications may cover displays 320, 330 respectively (or vice versa). Alternatively, the first visualization window generated by a first executed client application may cover display 330 whereas second and third visualization windows generated by subsequently-executed client applications may cover displays 310, 320 respectively (or vice versa). In yet another alternative configuration the first visualization window generated by a first executed client application may cover display 320 whereas second and third visualization windows generated by subsequently-executed client applications may cover displays 310, 330 respectively (or vice versa). In a further example the user may execute or launch the graphics client application 142 two times for generating two different and distinct visualization windows. The user may specify how each of the two visualization windows covers one or more of the display devices 310, 320, 330. Referring to FIG. 3, a first visualization window generated by a first executed client application may cover display 310 whereas the second visualization window generated by a subsequently-executed client application may cover displays 320 and 330. Similarly, the first visualization window generated by a first executed client application may cover display 330 whereas the second visualization window generated by a subsequently-executed client application may cover displays 310 and 320. Still further, in instances when only one visualization window is generated by executing or launching the graphics client application 142 a single time, the single visualization window may cover displays 310 and 320 or, alternatively, displays 320 and 330. Indeed, the visualization windows may be configured in various ways relative to the displays 310, 320, 330.

Referring now to FIG. 4, a third embodiment 400 of the display apparatus 160 (FIG. 1) is described. As shown in FIG. 1, the second embodiment 400 of display apparatus 160 includes four local displays 410, 420, 430, 440 configured in a two-by-two array arrangement. The first local display 410 is configured at the top left of the array horizontally adjacent to the second local display 420 and vertically adjacent to the third local display 430. The second local display 420 is configured at the top right of the array horizontally adjacent to the first local display 410 and vertically adjacent to the fourth local display 440. The third local display 430 is configured at the bottom left of the array horizontally adjacent to the fourth local display 440 and vertically adjacent to the first local display 410. The fourth local display 440 is configured at the bottom right of the array horizontally adjacent to the third local display 440 and vertically adjacent to the second local display 420. The first local display 410 includes a coordinate 412 and a resolution defined by the horizontal pixel dimension 114 and the vertical pixel dimension 416. Similarly, the second local display 420 includes a coordinate 422 and a resolution defined by the horizontal pixel dimension 424 and the vertical pixel dimension 426. The third local display 430 includes a coordinate 432 and a resolution defined by the horizontal pixel dimension 434 and the vertical pixel dimension 436. Finally, the fourth local display 440 includes a coordinate 442 and a resolution defined by the horizontal pixel dimension 444 and the vertical pixel dimension 446. For convenience of description hereinafter, vertical pixel dimensions 416, 426, 436, 446 are substantially similar and coordinate 412 is to be defined as the predetermined reference point or (0,0) pixel origin. However, vertical pixel dimensions 416, 426, 436, 446 being substantially similar should not be taken as limiting the present system and method. Furthermore, coordinate 412 being defined as the predetermined reference point or (0,0) pixel origin should not be taken as limiting the present system and method. Indeed, coordinates 422, 432, 442 or other point on one of the local displays 410, 420, 430, 440 may be used as the predetermined reference point as well. The overall or aggregate resolution of the display apparatus 400 is defined by the overall horizontal pixel dimension 450 and the overall vertical pixel dimension 460.

In view of the foregoing examples relative to FIGS. 2 and 3, it can be appreciated that the four displays 410-440 may be covered by one or more visualization windows. For example only one display (e.g., 410, 420, 430 or 440) may be covered by a single visualization window. In another example, only two horizontally adjacent displays (e.g., displays 410 and 420) may be covered by one or two visualization windows. In a further example it can be appreciated that only two vertically adjacent displays (e.g., displays 410 and 430) may be covered by one or two visualization windows. More particularly, when a user executes two client applications for generating two visualization windows, the user may specify a first visualization window having a portrait orientation for covering displays 410 and 430 (i.e., the first visualization window having a horizontal pixel dimension of 414 or 434 and a vertical pixel dimension of 460) and a second visualization window having a portrait orientation for covering displays 420 and 440 (i.e., the second visualization window having a horizontal pixel dimension of 424 or 444 and a vertical pixel dimension of 460). Still further, when a user executes two client applications for generating two visualization windows, the user may specify a first visualization window having a landscape orientation for covering displays 410 and 420 (i.e., the first visualization window having a horizontal pixel dimension of 414 plus 424 and a vertical pixel dimension of 416 or 426) and a second visualization window having a landscape orientation for covering displays 430 and 440 (i.e., the second visualization window having a horizontal pixel dimension of 434 plus 444 and a vertical pixel dimension of 436 or 446). Additionally, it should be appreciated that the visualization windows need not have the same orientation. For example, a first generated visualization window may be configured with a portrait orientation for covering displays 410 and 430 whereas a second generated visualization window may be configured with a landscape orientation for covering display 430 and 440, thereby overlapping display 430 with the first and second visualization windows and leaving the upper right display 420 out of the visualization sessions for displaying local resources. In view of the foregoing, it should be appreciated that each visualization window may overlay one or more local displays thus mapping to one or more virtual displays for each remote resource (e.g., each remote resource being accessed by a separate execution of the client application).

Although three embodiments 200, 300, 400 of the display apparatus 160 are provided, it should be appreciated that the display apparatus 160 may include additional local physical displays (i.e., more than four displays shown in FIG. 4) without limitation. Furthermore, it should be appreciated that the local physical displays constituting the display apparatus 160 may be arranged, oriented, positioned or otherwise configured in various ways without limitation. Moreover, although the illustrated embodiment 100 of the present system employs the display layout module 144 constituting the display quantity module 146 and the display arrangement module 148, other embodiments of the system may include a determination module 144 with additional or alternative modules, for example a module for determining angular orientation of a display—that is when a display is configured in an orientation that is neither of the conventional portrait nor the conventional landscape orientations determining module.

What is claimed is:

1. A display method for a remote visualization system (100) including a remote computer (120) and a local computer (140) connected with a plurality of physical displays (160), the method comprising:
detecting a quantity of physical displays in the plurality (160);
specifying one or more physical displays of the plurality (160) for displaying a visualization window, the visualization window being operable for accessing resources of the remote computer (120);
according to the specifying step, communicating to the remote computer (120) attributes which define the specified one or more physical displays;
according to the communicating step, generating a virtual display at the remote computer (120) relative to the communicated attributes, the virtual display substantially corresponding to the one or more physical displays;
substantially simultaneously with the generating step, displaying a visualization window on the specified one or more physical displays; and
mapping the virtual display to the visualization window.

2. The method of claim 1 further comprising:
transmitting, to the local computer (140), pixel information defining the virtual display for rendering in the visualization window covering the specified one or more physical displays.

3. The method of claim 1 wherein the detecting step comprises:
determining a resolution for each physical display of the plurality (160); and
determining an offset of each physical display of the plurality (160) from a reference point.

4. The method of claim 3 wherein the resolution is expressed in horizontal and vertical pixel dimensions, the horizontal and vertical pixel dimensions defining an orientation for each physical display of the plurality (160).

5. The method of claim 4 wherein the displaying step comprises configuring the visualization window to substantially cover the horizontal and vertical pixel dimensions of the specified one or more physical displays.

6. The method of claim 1 wherein the detecting step comprises executing a visualization client application on the local computer (140), the client application being operable for communicating with a visualization server application executing on the remote computer (120).

7. The method of claim 6 wherein the detecting step comprises the client application interfacing with BIOS or operating system of the local computer (140) for determining a configuration for each physical display of the plurality (160) relative to each other physical display of the plurality (160).

8. The method of claim 6 further comprising:
specifying at least one second physical display of the plurality of physical displays (160) for displaying a second visualization window, the second visualization wind being operable for accessing resources of a second remote computer;
repeating execution of the visualization client application with respect to the at least one second physical display;
according to the repeating step, communicating to the second remote computer second attributes which define the specified at least one second physical display;
generating a second virtual display at the second remote computer relative to the second attributes, the second virtual display substantially corresponding to the at least one second physical display;
substantially simultaneously with the step of generating a second virtual display, displaying a second visualization window on the specified at least one second physical display; and
mapping the second virtual display to the second visualization window.
